(19) United States
(12) Patent Application Publication
(10) Pub. No.: US 2025/0291101 A1
(43) Pub. Date: Sep. 18, 2025

(54) WAVEGUIDE FOR AUGMENTED REALITY DEVICES

(71) Applicant: CORNING INCORPORATED, CORNING, NY (US)

(72) Inventor: Vladimir Nikolaevich Borisov, Helsinki (FI)

(21) Appl. No.: 19/050,587

(22) Filed: Feb. 11, 2025

Related U.S. Application Data
(60) Provisional application No. 63/565,629, filed on Mar. 15, 2024.

(51) Int. Cl. F21V 8/00

(52) U.S. Cl. CPC G02B 6/0016; G02B 6/0036

(57) ABSTRACT

A waveguide for augmented reality devices is described. The waveguide may be incorporated into an optical element that further includes an incoupling grating and an outcoupling grating. Imaging light is directed into the incoupling grating and diffracted into the waveguide. The diffracted light propagates within the waveguide to the outcoupling grating and is diffracted to the viewing field of a user of the device. The waveguide features a non-uniform refractive index profile that improves the brightness uniformity of light diffracted from the outcoupling grating.

This Application claims the benefit of priority to U.S. Provisional Patent Application Ser. No. 63/565,629 filed on Mar. 15, 2024, the content of which is relied upon and incorporated herein by reference in its entirety.

### FIELD

This description relates to waveguides for use in augmented reality devices. More particularly, this description relates to waveguides designed to improve brightness uniformity at the exit pupil. Most particularly, this description relates to waveguides with a graded refractive index that acts to minimize differences in replicate spacing of light entering the waveguide at different incidence angles.

### BACKGROUND

Augmented reality devices are gaining in consumer acceptance as the dimensions decrease and more socially acceptable form factors are developed. An augmented reality generates a virtual image and superimposes it on the viewing field of an observer. The virtual image includes information that supplements, enhances, or interprets objects in the viewing field. A common design for augmented reality devices is based on a combination of optical elements that include imaging optics, a waveguide, and light-coupling elements. The imaging optics generate a virtual image and direct it to an entrance light-coupling element. The entrance light-coupling element couples the imaging light into the waveguide whereupon it is transmitted within the waveguide to an exit light-coupling element that directs it to a specified location in the observer's field of view. The entrance and exit light-coupling elements are typically diffraction gratings and light is typically coupled into and out of the waveguide by diffraction.

Light provided by the imaging optics is typically non-collimated and approaches the entrance light-coupling element as a series of components that span a range of incidence angles. Upon diffraction into the waveguide by the entrance light-coupling element, the range of incidence angles produces components of diffracted light in the waveguide that transmit over a range of propagation angles to the exit light-coupling element. The mechanism of propagation within the waveguide is typically total internal reflection. The intensity of light diffracted as output light by the exit light-coupling element is proportional to the number of replicates of the light transmitted to the exit light-coupling element. The exit light-coupling element has finite dimensions, and the number of replicates depends on the replication distance of the components of diffracted light propagating within the waveguide. The replication distance corresponds to one period of total internal reflection in the waveguide and varies with the incidence angle of the imaging light coupled into the waveguide by the entrance light-coupling element. The range of incidence angles leads to a range of propagation angles and a range of replication distances for the components of light transmitted within the waveguide. A range of replication distances, however, leads to variability in the brightness of light coupled out of the waveguide by the exit light-coupling element into the observer's field of view. Some components of light are diffracted into the observer's field of view with higher brightness than other components. Non-uniformity of brightness detracts from the quality of the virtual image perceived by the observer. It would accordingly be desirable to develop optical elements and waveguides for augmented reality devices that improve the brightness uniformity of virtual images.

### SUMMARY

The present disclosure provides a waveguide that can be used in augmented reality and other light guiding devices. The waveguide may be incorporated into an optical element that further includes an incoupling grating and an outcoupling grating. The incoupling and outcoupling gratings may be interfaced with or formed on a surface of the waveguide. Imaging light is directed into the incoupling grating and diffracted into the waveguide. The diffracted light propagates within the waveguide to the outcoupling grating and is diffracted to the viewing field of a user of the device. The waveguide features a non-uniform refractive index that improves the brightness uniformity of light diffracted from the outcoupling grating.

The present disclosure extends to:

An optical element comprising:
an entrance light-coupling element, the entrance light-coupling element configured to diffract light received over a field of view defined by a first angular range, the light comprising a wavelength in the range from 440 nm to 650 nm, the first angular range comprising a plurality of incidence angles α extending from a minimum incidence angle αₘᵢₙ to a maximum incidence angle αₘₐₓ;
a waveguide, the waveguide configured to receive the light diffracted by the entrance light-coupling element and to transmit the diffracted light internally over a second angular range to a first exit light-coupling element, the second angular range comprising a plurality of propagation angles θ extending from a minimum propagation angle θₘᵢₙ to a maximum propagation angle θₘₐₓ, the light transmitted at each of the propagation angles θ having a replication distance γ, the light transmitted over the second angular range including a maximum replication distance γₘₐₓ at the maximum propagation angle and a minimum replication distance γₘᵢₙ the minimum propagation angle, the ratio

$$\frac{{γ}_{max}}{{γ}_{min}}$$

less than or equal to 6.0, the first exit light-coupling element diffracting the transmitted light out of the waveguide.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1A is a depiction of internal transmission of diffracted light in a waveguide with two exit light-coupling elements.

FIG. 1B is a depiction of internal transmission of diffracted light in a waveguide with one exit light-coupling element.

FIG. 2 depicts an angle of propagation of imaging light diffracted into a waveguide through an entrance light-coupling element.

FIG. 3 shows a variation in replication distance of light propagating in a waveguide at different propagation angles.

FIG. 4 depicts uniform refractive index profiles and non-uniform refractive index profiles at wavelengths of 440 nm, 532 nm, and 650 nm.

FIG. 5 depicts replication distance as a function of propagation angle for the refractive index profiles shown in FIG. 4.

FIG. 6 depicts maximum and minimum replication distances for waveguides having the refractive index profiles shown in FIG. 4.

FIG. 7 depicts uniform refractive index profiles and non-uniform refractive index profiles at wavelengths of 440 nm, 532 nm, and 650 nm.

FIG. 8 depicts replication distance as a function of propagation angle for the refractive index profiles shown in FIG. 7.

FIG. 9 depicts uniform refractive index profiles and non-uniform refractive index profiles at wavelengths of 440 nm, 532 nm, and 650 nm.

FIG. 10 depicts replication distance as a function of propagation angle for the refractive index profiles shown in FIG. 9.

FIG. 11 depicts uniform refractive index profiles and non-uniform refractive index profiles for monochromatic light.

FIG. 12 depicts replication distance as a function of propagation angle for the refractive index profiles shown in FIG. 11.

FIG. 13 depicts uniform refractive index profiles and non-uniform refractive index profiles for monochromatic light.

FIG. 14 depicts replication distance as a function of propagation angle for the refractive index profiles shown in FIG. 13.

FIG. 15 depicts uniform refractive index profiles and non-uniform refractive index profiles for monochromatic light.

FIG. 16 depicts replication distance as a function of propagation angle for the refractive index profiles shown in FIG. 15.

FIG. 17 depicts a waveguide with a gradient index supported on a thick low-index substrate.

FIG. 18 depicts a transformation of a continuous gradient in refractive index to a discrete or layered gradient in refractive index.

FIG. 19 depicts a uniform refractive index profile and a non-uniform refractive index profile.

FIG. 20 depicts replication distance as a function of propagation angle for the refractive index profiles shown in FIG. 19.

The embodiments set forth in the drawings are illustrative in nature and not intended to be limiting of the scope of the detailed description or claims. Whenever possible, the same reference numeral will be used throughout the drawings to refer to the same or like feature.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

The present disclosure describes optical elements and waveguides that can be used in augmented reality and other light guiding devices. The optical elements or waveguides include an entrance light-coupling element and an exit light-coupling element. Light-coupling elements include diffraction gratings such as an incoupling grating, which diffracts imaging light into the waveguide, and an outcoupling grating, which diffracts light out of the waveguide. The optical elements or waveguides may also include an expanding element, such as an exit pupil expander, which may also be a grating. The expanding element may be integrated with or separate from a light-coupling element. Gratings include 1D gratings, 2D gratings, holographic gratings, and may also include multiple layers of gratings. The incoupling and outcoupling gratings may be interfaced with or formed on a surface of the waveguide. The incoupling and outcoupling grating may be integrated into or onto a surface of the waveguide. Imaging light is directed to the incoupling grating and diffracted by the incoupling grating into the waveguide. The diffracted light propagates within the waveguide to the outcoupling grating and is diffracted by the outcoupling grating to the viewing field of a user of the device. The waveguide features a non-uniform refractive index that improves the brightness uniformity of light diffracted from the outcoupling grating.

Disclosed are components (including materials, compounds, compositions, and method steps) that can be used for, in conjunction with, in preparation for, or as embodiments of the disclosed reflecting optical elements and methods for making reflecting optical elements. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

In this specification and in the claims which follow, reference will be made to a number of terms which shall be defined to have the following meanings:

“Include,” “includes,” or like terms means encompassing but not limited to, that is, inclusive and not exclusive.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening materials. Elements in contact may be rigidly or non-rigidly joined. Contacting refers to placing two elements in direct or indirect contact. Elements in direct (indirect) contact may be said to directly (indirectly) contact each other.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

The indefinite article “a” or “an” and its corresponding definite article “the” as used herein means at least one, or one or more, unless specified otherwise.

The claims as set forth below are incorporated into and constitute part of this Detailed Description.

Reference will now be made in detail to illustrative embodiments of the present description.

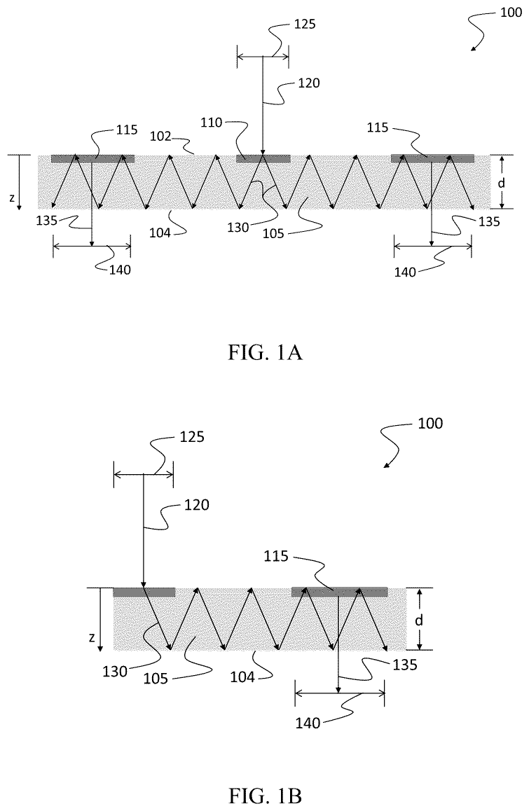

FIG. 1A illustrates an optical element configured for use in an augmented reality device. Optical element 100 includes waveguide 105, incoupling grating 110 (entrance light-coupling element), and outcoupling gratings 115 (exit light-coupling gratings). Waveguide 105 includes an incidence surface 102 and a back surface 104. Incidence surface 102 is the surface of waveguide 105 upon which imaging light 120 is incident and back surface 104 opposes incidence surface 102. Waveguide 105 has a thickness d and a thickness direction z. Thickness refers to the smallest linear dimension describing the shape of waveguide 105 (e.g., the smallest of length, width, and height for a planar waveguide, or the smaller of diameter and height for a cylindrical or disk-shaped waveguide). The coordinate z defining the thickness direction has a value of zero at the incidence surface 102 and increases in the direction toward back surface 104. In standard designs, waveguide 105 has a uniform refractive index n_{d}. FIG. 1B shows a corresponding embodiment of an optical element having a single outcoupling grating 115.

Imaging light 120 representing a virtual image is provided by an imager (typically consisting of a microdisplay and optics) (not shown). Imaging light 120 is monochromatic or polychromatic. Imaging light 120 preferably includes one or more wavelengths between 400 nm and 700 nm, such as, for example, red, green, and/or blue light. The exit pupil of the imager is depicted at 125. The imaging light 120 is directed to an incoupling grating 110 (corresponding to an entrance light-coupling element), which diffracts the imaging light 120 into waveguide 105. Diffracted light 130 is monochromatic or polychromatic. Diffracted light 130 transmits internally within waveguide 105 (e.g., by total internal reflection) and reaches outcoupling gratings 115 (corresponding to exit light-coupling elements). Outcoupling gratings 115 diffract the transmitted light out of waveguide 105 as output light 135 having exit pupil 140, which is directed to a viewer. Output light 135 is monochromatic or polychromatic. The outcoupling gratings 115, for example, may direct a virtual image to each eye of a user wearing the augmented reality device. Exit pupil 125 of the imager corresponds or approximately corresponds to the width of incoupling grating 110. Exit pupil 140 corresponds or approximately corresponds to the width of outcoupling grating 115. In the embodiment depicted in FIG. 1A, the outcoupling gratings 115 are symmetrically disposed about the incoupling grating 110. In the embodiment depicted in FIG. 1B, diffracted light 130 is transmitted in one direction within waveguide 105 from incoupling grating 110 to outcoupling grating 115.

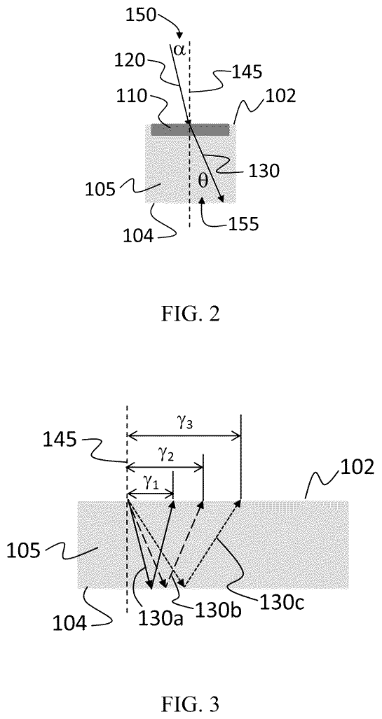

Although not depicted explicitly in the schematic of FIGS. 1A and 1B, it is understood in the art that imaging light 120 includes light that spans a range of incidence angles to incoupling grating 120 and that upon diffraction, light spanning a range of propagation angles is transmitted internally in this embodiment by total internal reflection within waveguide 105. FIG. 2 shows an enlargement of a portion of optical element 100 in the vicinity of incoupling grating 110. Shown is a component of imaging light 120 that approaches incidence surface 102 at an angle of incidence α (depicted at 150) relative to normal 145 to incidence surface 102. The depicted component of imaging light 120 is diffracted by incoupling grating 110 to form a component of diffracted light 130 having an angle of propagation θ (depicted at 155). Imaging light 120 includes multiple components that approach incidence surface 102 over a range of incidence angles α. The range of incidence angles α extends from a minimum incidence angle αₘᵢₙ to a maximum incidence angle αₘₐₓ. The multiple components of imaging light 120 are diffracted by incoupling grating 110 to form multiple components of diffracted light 130 that are transmitted over a range of propagation angles θ. The range of propagation angles θ extends from a minimum propagation angle θₘᵢₙ to a maximum propagation angle θₘₐₓ.

Selection of the imager and its operation to provide a desired virtual image controls the distribution of incidence angle α for the components of imaging light 120. In principle, the incidence angle α can range from −90° to 90°. In various embodiments, the absolute value of the incidence angle α ranges from 5° to 85°, or from 5° to 70°, or from 5° to 55°, or from 5° to 40°, or from 5° to 25°, or from 10° to 80°, or from 10° to 70°, or from 10° to 55°, or from 10° to 40°, or from 10° to 25°, or from 15° to 75°, or from 15° to 70°, or from 15° to 55°, or from 15° to 40°, or from 15° to 25°, or from 20° to 70°, or from 25° to 65°, or from 30° to 60°, or from 35° to 55°. The minimum absolute value of the incidence angle αₘᵢₙ is greater than or equal to 5°, or greater than or equal to 10°, or greater than or equal to 15°, or greater than or equal to 20°, or greater than or equal to 25°, or greater than or equal to 30°, or greater than or equal to 35°, or less than or equal to 50°, or less than or equal to 45°, or less than or equal to 40°, or in the range from 5° to 50°, or in the range from 10° to 45°, or in the range from 15° to 40°, or in the range from 20° to 35°. The maximum absolute value of the incidence angle αₘₐₓ is greater than or equal to 50°, or greater than or equal to 55°, or greater than or equal to 60°, or greater than or equal to 65°, or greater than or equal to 70°, or greater than or equal to 75°, or greater than or equal to 80°, or less than or equal to 90°, or less than or equal to 70°, or less than or equal to 60°, or less than or equal to 50°, or less than or equal to 30°, or less than or equal to 20°, or in the range from 10° to 50°, or in the range from 10° to 40°, or in the range from 10° to 30°, or in the range from 50° to 90°, or in the range from 55° to 85°, or in the range from 60° to 80°.

The incoupling grating 110 provides diffracted light 130 with a one-to-one correspondence of propagation angle θ to incidence angle α. That is, components of imaging light 120 at each incidence angle α within a range of incidence angles α are diffracted by incoupling grating 110 into components of diffracted light 130 over a range of propagation angles θ, where the components of diffracted light 130 at each propagation angle θ originate from a distinct component of imaging light 120 at a distinct angle of incidence α such that a correlation exists between each incidence angle a and one of the propagation angles θ. The nature of the correlation depends on characteristics of incoupling grating 110 (e.g., grating spacing). For applications in augmented reality, it is preferable for the range of propagation angles θ of the components of diffracted light 130 to include, in whole or in part, the range of angles over which total internal reflection of diffracted light 130 within waveguide 105 is supported. In various embodiments, the propagation angle θ ranges from 25° to 85°, or from 30° to 80°, or from 35° to 75°, or from 40° to 70°, or from 45° to 65°. In other embodiments, the range of propagation angles 0 includes greater than or equal to 50%, or greater than or equal to 60%, or greater than or equal to 70%, or greater than or equal to 80%, or greater than or equal to 90%, or between 50% and 100%, or between 55% and 95%, or between 60% and 90% of the range of angles capable of being transmitted internally by total internal reflection within waveguide 105.

The minimum propagation angle θₘᵢₙ is greater than or equal to 5°, or greater than or equal to 10°, or greater than or equal to 15°, or greater than or equal to 20°, or greater than or equal to 25°, or greater than or equal to 30°, or greater than or equal to 35°, or less than or equal to 50°, or less than or equal to 45°, or less than or equal to 40°, or in the range from 5° to 50°, or in the range from 10° to 45°, or in the range from 15° to 40°, or in the range from 20° to 35°. The maximum propagation angle θₘₐₓ is greater than or equal to 50°, or greater than or equal to 55°, or greater than or equal to 60°, or greater than or equal to 65°, or greater than or equal to 70°, or greater than or equal to 75°, or greater than or equal to 80°, or less than or equal to 90°, or less than or equal to 85°, or less than or equal to 80°, or in the range from 50° to 90°, or in the range from 55° to 85°, or in the range from 60° to 80°.

In one embodiment, the minimal propagation angle θₘᵢₙ is defined by the theoretical limit of the critical angle for total internal reflection, which corresponds to sin⁻¹(1/n) for a single layer waveguide, where n is the refractive index at the surface of incidence. If the waveguide has a refractive index of 2, the minimal propagation angle θₘᵢₙ is 30 degrees. In another embodiment, the maximum propagation angle θₘₐₓ is determined by the “just-filled” condition of the incoupling grating, which can be calculated as tan⁻¹(s/2d), where s is the size of incoupling grating, and d is the thickness of the waveguide.

Differences in propagation angle θ for different components of diffracted light 130 lead to differences in the paths traversed by the components of diffracted light 130 as they are transmitted in waveguide 105 between incoupling grating 110 and outcoupling grating 115. In particular, components of diffracted light 130 that propagate at small propagation angles θ undergo a larger number of reflections between incidence surface 102 and back surface 104 as they propagate from incoupling grating 110 to outcoupling grating 115. FIG. 3 illustrates propagation of three components 130a, 130b, and 130c of diffracted light 130. Component 130a transmits at a smaller propagation angle θ than component 130b, which transmits at a smaller propagation angle θ than component 130c. A period of reflection is shown for each of components 130a, 130b, and 130c. By period of reflection is meant a portion of the path of transmittance extending once at the propagation angle θ from incidence surface 102 to back surface 104 and once back to incidence surface 102. The period of reflection is replicated multiple times as components of diffracted light 130 are transmitted from incoupling grating 110 to outcoupling grating 115. For each component of diffracted light 130, a replication distance γ can be defined where the replication distance γ corresponds to the length of one period of reflection along incidence surface 102. FIG. 3 shows respective replication distances γ₁, γ₂, and γ₃ for components 130a, 130b, and 130c of diffracted light 130. Of the three components, component 130a has the smallest propagation angle θ and smallest replication distance γ, component 130c has the largest propagation angle θ and the largest replication distance γ, and component 130b has an intermediate propagation angle θ and an intermediate replication distance γ. In the general case, diffracted light 130 includes a continuum of components spanning a continuum of propagation angles θ with replication distances γ that extend from a minimum replication distance γₘᵢₙ to a maximum replication distance γₘₐₓ.

Differences in the replication distance γ lead to differences in the number of periods of reflection that overlap the outcoupling grating 115 for the different components of diffracted light 130. Differences in overlap lead to differences in the brightness of light diffracted as output light 135 from outcoupling grating 115. Components of diffracted light 130 with short replication distances γ have a greater number of periods of reflection that overlap outcoupling grating 115 and are accordingly diffracted with higher brightness than components of diffracted light 130 having longer replication distances γ and an overlap of fewer periods of reflection with outcoupling grating 115. Of the three components of diffracted light 130 depicted in FIG. 3, for example, component 130a has the shortest replication distance, the greatest number of periods of reflection that overlap outcoupling grating 115 and the highest brightness in output light 135 diffracted from outcoupling grating 115.

A non-uniformity in the brightness of components in output light 135 accordingly results from differences in the propagation angle θ of the components of diffracted light 130, which in turn are due to differences in the incidence angle α of imaging light 120. The non-uniformity in brightness increases as the difference γₘₐₓ−γₘᵢₙ increases, or, alternatively, as the ratio γₘₐₓ/γₘᵢₙ increases. For many applications of augmented reality, it would be desirable to minimize non-uniformities in brightness and to achieve output light 135 with components similar in brightness irrespective of the incidence angle α or the propagation angle θ.

The present disclosure provides an optical element with a waveguide that improves the brightness uniformity of the output light. The waveguides disclosed herein achieve greater uniformity in brightness by minimizing the difference between the maximum replication distance γₘₐₓ and the minimum replication distance γₘᵢₙ or by minimizing the ratio γₘₐₓ/γₘᵢₙ Without wishing to be bound by theory, it is recognized that the non-uniformity in brightness observed for optical elements with conventional waveguides originates from the constant refractive index of the waveguide used in the standard design.

The present disclosure provides waveguides having a non-uniform refractive index configured to minimize differences in the replication distance of components of imaging light that differ in incidence angle a or components of diffracted light that differ in propagation angle θ. The non-uniform refractive index is designed to reduce the ratio γₘₐₓ/γₘᵢₙ so that greater uniformity of brightness of output light 135 is provided by outcoupling gratings 115. The non-uniform refractive index is defined in terms of a non-uniform refractive index profile, which describes the spatial variation of refractive index in the waveguide. In one embodiment, the non-uniform refractive index profile of the waveguide is a graded refractive index profile in which the refractive index varies in the thickness direction of the waveguide. In one embodiment, the non-uniform refractive index varies continuously in the thickness direction between incidence surface 102 and back surface 104 of waveguide 105. In another embodiment, the non-uniform refractive index varies discretely in a stepwise fashion in the thickness direction between incidence surface 102 and back surface 104 of waveguide 105. In yet another embodiment, the refractive index of the non-uniform refractive index profile is highest at incidence surface 102 and decreases monotonically or stepwise in the thickness direction toward back surface 104. The monotonic or stepwise decrease occurs over all or part of the thickness direction. In a further embodiment, the refractive index is highest at incidence surface 102 and lowest at back surface 104.

The non-uniform refractive index profile includes a maximum refractive index and a minimum refractive index. In embodiments, the minimum refractive index is greater than or equal to 1.00, or greater than or equal to 1.10, or greater than or equal to 1.20, or greater than or equal to 1.30, or greater than or equal to 1.40, or greater than or equal to 1.50, or less than or equal to 2.00, or less than or equal to 1.90, or less than or equal to 1.80, or less than or equal to 1.70, or in the range from 1.00 to 2.00, or in the range from 1.10 to 1.90, or in the range from 1.20 to 1.80, or in the range from 1.30 to 1.70, or in the range from 1.00 to 1.60, or in the range from 1.00 to 1.50, or in the range from 1.10 to 1.60, or in the range from 1.10 to 1.50. In embodiments, the maximum refractive index is greater than or equal to 1.50, or greater than or equal to 1.60, or greater than or equal to 1.70, or greater than or equal to 1.80, or greater than or equal to 1.90, or greater than or equal to 2.00, or less than or equal to 3.00, or less than or equal to 2.80, or less than or equal to 2.60, or less than or equal to 2.40, or in the range from 1.50 to 3.00, or in the range from 1.60 to 2.80, or in the range from 1.70 to 2.60, or in the range from 1.80 to 2.40, or in the range from 1.90 to 2.20, or in the range from 1.80 to 2.20, or in the range from 1.70 to 2.20, or in the range from 1.60 to 2.20.

In other embodiments, the difference between the maximum refractive index and the minimum refractive index is greater than or equal to 0.20, or greater than or equal to 0.40, or greater than or equal to 0.60, or greater than or equal to 0.80, or greater than or equal to 1.00, or in the range from 0.20 to 1.20, or in the range from 0.30 to 1.10, or in the range from 0.40 to 1.00, or in the range from 0.50 to 0.90. In further embodiments, the non-uniform refractive index profile includes a constant or non-constant gradient of refractive index in the thickness direction of waveguide 105, where the average gradient in refractive index is greater than or equal to 0.50/mm, or greater than or equal greater than or equal to 0.75/mm, or greater than or equal to 1.00/mm, or greater than or equal to 1.25/mm, or greater than or equal to 1.50/mm, or greater than or equal to 1.75/mm, or greater than or equal to 2.00/mm, or in the range from 0.50/mm to 2.25/mm, or in the range from 0.75/mm to 2.00/mm, or in the range from 1.00/mm to 1.75/mm, or in the range from 1.25/mm to 2.25/mm, or in the range from 1.50/mm to 2.25/mm, where the average gradient in refractive index is expressed as the change in index per mm of distance in the thickness direction of waveguide 105. For example, a waveguide having a non-uniform refractive profile with a gradient with a maximum index of 2.00 at incidence surface 102, a minimum index of 1.00 at back surface 104, and a thickness d=1 mm has an average gradient in refractive index of 1.00/mm.

Waveguide 105 has a thickness d of greater than 0.01 mm, or greater than 0.05 mm, or greater than 0.1 mm, or greater than 0.2 mm, or greater than 0.4 mm, or greater than 0.6 mm, or greater than 0.8 mm, or greater than 1.0 mm, or greater than 1.2 mm, or greater than 1.4 mm, or less than 6.0 mm, or less than 5.0 mm, or less than 4.0 mm, or less than 3.0 mm, or less than 2.0 mm, or less than 1.0 mm, or in the range from 0.01 mm to 6.0 mm, or in the range from 0.01 mm to 4.0 mm, or in the range from 0.01 mm to 2.0 mm, or in the range from 0.05 mm to 6.0 mm, or in the range from 0.05 mm to 4.0 mm, or in the range from 0.05 mm to 2.0 mm, or in the range from 0.1 mm to 2.0 mm, or in the range from 0.2 mm to 1.8 mm, or in the range from 0.3 mm to 1.6 mm, or in the range from 0.4 mm to 1.4 mm, or in the range from 0.5 mm to 1.2 mm, or in the range from 0.6 mm to 1.0 mm, or in the range from 0.1 mm to 6.0 mm, or in the range from 0.2 mm to 5.0 mm, or in the range from 0.3 mm to 4.0 mm. Waveguide 105 may be a standalone optical element 100 or may be in direct contact with other layers or materials of optical element 100. For example, optical element 100 may include a laminate structure in which waveguide 105 is one of a series of layers. In a further example, waveguide 105 may include a coating, such as an anti-reflective coating or a scratch-resistant coating in direct contact with either or both of incident surface 102 and back surface 104. In some embodiments, waveguide 105 is planar. In other embodiments, waveguide 105 is curved.

In one embodiment, a non-uniform refractive index profile is achieved through a variation in the composition of waveguide 105 in the thickness direction. A continuous variation in composition provides a continuous variation in refractive index. A preferred material for waveguide 105 is glass. Glasses include phosphates and silicates, including modified forms thereof (e.g., borosilicates, borophosphates, aluminosilicates, aluminophosphates, glass doped with alkali or alkaline earth metals, etc.). High-index modifiers are modifiers conducive to increasing the refractive index of glass. High-index modifiers include TiO₂, Nb₂O₅, Bi₂O₃, WO₃, and rare earth oxides (e.g., La₂O₃, Y₂O₃, Gd₂O₃). A non-uniformity in the concentration of one or more high-index modifiers leads to a non-uniformity in refractive index. A continuously decreasing concentration of high-index modifiers in the thickness direction of a waveguide, for example, leads to a continuously decreasing refractive index in the thickness direction of the waveguide. Variations in the concentrations of high-index modifiers can be achieved during glass formation by controlling the timing, placement, and amount of high-index modifiers during the batching and melting process. A gradient in the concentration of high-index modifiers in a melt leads to a gradient in the concentration of high-index modifiers in glasses formed from the melt. Other methods of forming compositional gradients in glass include diffusion (in the melt or by contact with a solution) and implantation. Representative compositions of glasses having high refractive index are given in U.S. Pat. Nos. 11,802,073; 11,472,731; 11,479,499; and 11,485,676; and also in U.S. Published patents application Ser. Nos. 20/220,073409, 20220073410, 20230339803, 20230339801, and 20230303426; the disclosures of which are incorporated by reference herein.

### EXAMPLES—INDEX GRADIENT—POLYCHROMATIC LIGHT

The following examples illustrate the effect of selected non-uniform refractive index profiles on replication distance γ and the ratio γₘₐₓ/γₘᵢₙ in waveguides. The results presented are based on models of light propagation by total internal reflection in waveguides. Propagation angles and ray trajectories were computed using the beam propagation method (see Zhong, H., et al., Journal of the Optical Society of America A, 35(41), 661-668 (2018)). The effects of dispersion are included by considering representative red (650 nm), green (532 nm), and blue (440 nm) wavelengths. The results are valid for incident light including one or more wavelengths between 440 nm and 650 nm. In a dispersive medium, the range of propagation angles associated with waveguiding by total internal transmission depends on wavelength. Longer wavelengths propagate at larger propagation angles than shorter wavelengths. For purposes of the model, the maximum propagation angle was set to 80° for the red wavelength (650 nm). The angle of incidence 60 a extends from αₘᵢₙ=−α′ to αₘₐₓ=α′ where α′ is given by

$${α}^{′} = {sin}^{- 1} ( \frac{2 sin ( 80 ° ) - 650 / 440}{1 + 650 / 440} ) = 11.46 °$$

The minimum propagation angle θₘᵢₙ and maximum propagation angle θₘₐₓ are given by:

$$\begin{matrix}{θ}_{min} = {sin}^{- 1} ( \frac{λ * ( 1 + 2 sin ( 8 {0}^{∘} ) ) - 440 * ( 2 sin ( 8 {0}^{∘} ) - 650 / 440 )}{2 * 440 * ( 1 + 650 / 440 )} ) \\ {θ}_{max} = {sin}^{- 1} ( \frac{λ * ( 1 + 2 sin ( 8 {0}^{∘} ) ) + 440 * ( 2 sin ( 8 {0}^{∘} ) - 650 / 440 )}{2 * 440 * ( 1 + 650 / 440 )} )\end{matrix}$$

and lead to the ranges listed in Table 1.

TABLE 1

| λ (nm) | θₘᵢₙ | θₘₐₓ |
|---|---|---|
| 440 | 30.00° | 44.33° |
| 532 | 38.71° | 55.49° |
| 650 | 51.82° | 80.00° |

with the total range of propagation angle θ extending from 30.00° to 80.00°.

Dispersion is characterized by the parameter V, which is given by

$$V = \frac{{n}_{532} - 1}{{n}_{440} - {n}_{650}}$$

where n₅₃₂ is the refractive index at 532 nm, n₄₄₀ is the refractive index at 440 nm, is n₆₅₀ is the refractive index at 650 nm and by the following relation between n₅₃₂, n₄₄₀, and n₆₅₀:

$$\frac{{n}_{532} - {n}_{650}}{{{n}_{440}}_{} - {n}_{650}} = \frac{1}{4}$$

From these equations, the refractive index n₅₃₂ and the refractive index n₄₄₀ can be expressed as

$${n}_{532} = \frac{4 * V * {n}_{650} - 1}{4 * V - 1}$$

$$and$$

$${n}_{440} = \frac{( 4 * V + 3 ) * {n}_{650} - 4}{4 * V - 1} .$$

It is preferable in applications to augmented reality for waveguides to have low dispersion. Accordingly, the following constraint is placed on V:

$$V \geq 16 \; 0 * 0.2 {5}^{{n}_{650}}$$

$$where$$

$${V}_{min} = 160 * 0.2 {5}^{{n}_{650}}$$

corresponds to the minimum value of V that provides acceptably low dispersion for purposes of the present disclosure. The results disclosed herein apply to waveguide materials and structures (e.g., laminates or waveguide layers on substrates) satisfying the condition V≥Vₘᵢₙ. In the modelling that follows, n₅₃₂ and n₄₄₀ are computed using n₆₅₀ and Vₘᵢₙ.

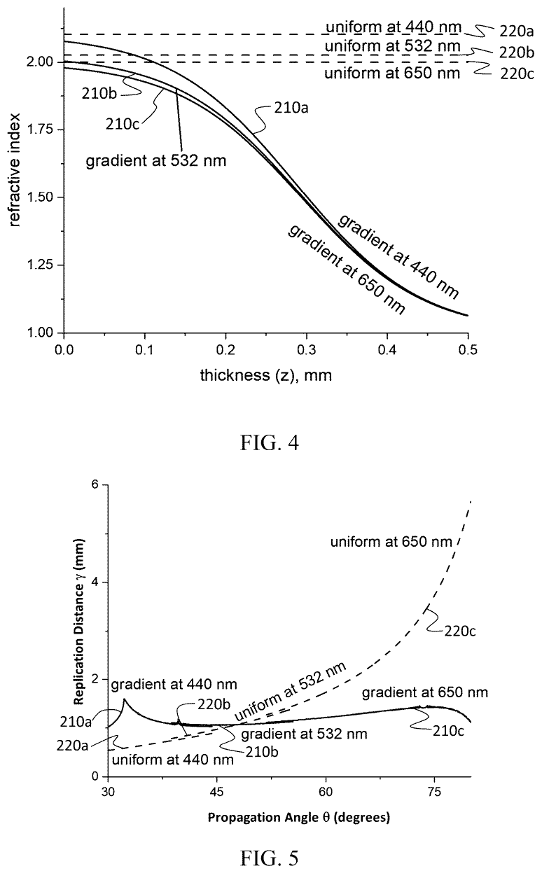

FIG. 4 is a plot of refractive index as a function of position in the thickness direction z of a waveguide having a thickness d=0.5 mm. FIG. 4 shows non-uniform refractive index profiles 210a, 210b, and 210c with a gradient at wavelengths of 440 nm, 532 nm, and 650 nm, respectively, and corresponding comparative uniform refractive index profiles 220a, 220b, and 220c at wavelengths of 440 nm, 532 nm, and 650 nm, respectively. Uniform refractive index profile 220c has an index of 2.00 throughout the thickness direction. Non-uniform refractive index profile 210c has a maximum value of about 1.98 at incident surface 102 (z=0 mm) and decreases monotonically in the thickness direction to a minimum value of about 1.06 at back surface 104 (z=0.5 mm). The variation in refractive index of non-uniform refractive index profile 210c can be expressed as

$${n}_{650} ( z ) = 1 + {( 1 + {e}^{13.1 * ( z - 0.294 )} )}^{- 1}$$

where n₆₅₀(z) represents refractive index as a function of z, the coordinate measuring position in the thickness direction, and z is expressed in units of mm. The average gradient of non-uniform refractive index profile 210c is about 1.84/mm. Uniform refractive index profile 220b was determined from uniform refractive index profile 220c and has a refractive index of 2.026. Uniform refractive index profile 220a was determined from uniform refractive index profile 220c and has a refractive index of 2.102. Non-uniform refractive index profiles 210a and 210b were determined from non-uniform refractive index profile 210c using the formulas above and Vₘᵢₙ.

FIG. 5 shows the variation of replication distance γ with propagation angle θ for non-uniform refractive index profiles 210a, 210b, and 210c and for uniform refractive index profiles 220a, 220b, and 220c propagation angle θ. The range of propagation angle for each wavelength extends from θₘᵢₙ to θₘₐₓ, where θₘᵢₙ and θₘₐₓ are given in Table 1 above. The replication distance γ for uniform refractive index profiles 220a, 220b, and 220c show an appreciable increase as the propagation angle θ increases. The replication distance γ for non-uniform refractive index profiles 210a, 210b, and 210, in contrast, are comparatively constant as the propagation angle θ increases.

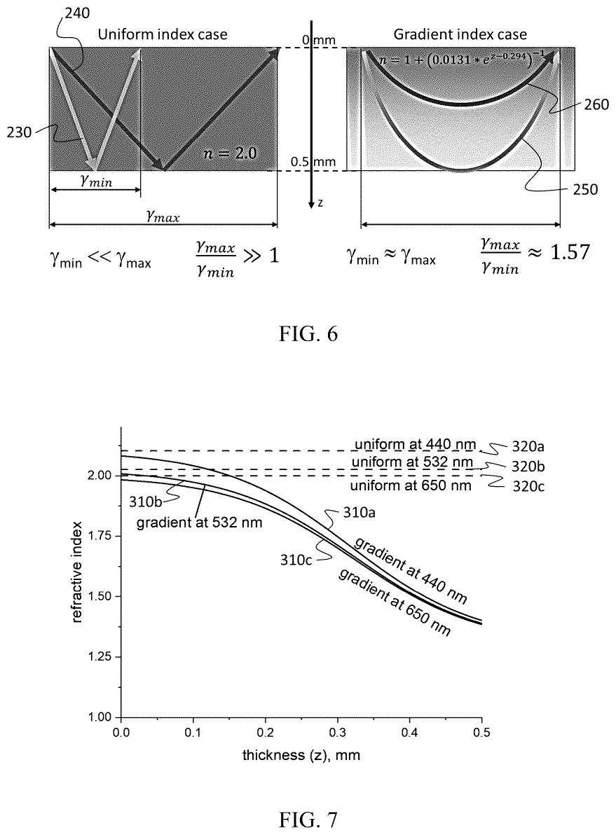

FIG. 6 shows propagation of selected components of diffracted light 130 in waveguide 105 with the refractive index profiles shown in FIG. 4. The left side of FIG. 6 depicts waveguide 105 with uniform refractive index profiles 220a, 220b, and 220. The right side of FIG. 6 depicts waveguide 105 with non-uniform refractive index profiles 210a, 210b, and 210c. Two components of diffracted light 130 are shown for each waveguide. The angles and trajectories of the rays shown in FIG. 6 are schematic and not necessarily drawn to scale. Diffracted component 230 represents the component of diffracted light 130 with propagation angle θ=30° and λ=440 nm in waveguide 105 with uniform refractive index profile 220a. Diffracted component 240 represents the component of diffracted light 130 with propagation angle θ=80° and λ=650 nm in waveguide 105 with uniform refractive index profile 220c. Diffracted component 230 represents the component of diffracted light 130 with the minimum replication distance γₘᵢₙ in waveguide 105 with any of uniform refractive index profiles 220a, 220b, and 220c or any uniform refractive index profile for a wavelength between 440 nm and 650 nm. Diffracted component 240 represents the component of diffracted light 130 with the maximum replication distance γₘₐₓ in waveguide 105 with any of uniform refractive index profiles 220a, 220b, and 220c or any uniform refractive index profile for a wavelength between 440 nm and 650 nm. It is evident from the left side of FIG. 6 that when waveguide 105 has a uniform refractive index profile, the difference between γₘₐₓ and γₘᵢₙ is large and the ratio γₘₐₓ/γₘᵢₙ>>1. Calculations indicate that the ratio γₘₐₓ/γₘᵢₙ=10.45 for wavelengths between 440 nm and 650 nm in a waveguide 105 with thickness 0.5 mm and uniform refractive index.

Diffracted component 250 represents the component of diffracted light 130 with propagation angle θ=30° and λ=440 nm in waveguide 105 with non-uniform refractive index profile 210a. Diffracted component 260 represents the component of diffracted light 130 with propagation angle θ=80° and λ=650 nm in waveguide 105 with non-uniform refractive index profile 210c. Diffracted component 250 represents the component of diffracted light 130 with the minimum replication distance γₘᵢₙ in waveguide 105 with any of the non-uniform refractive index profiles 210a, 210b, and 210c or any non-uniform refractive index profile subject to the dispersion constraint V≥Vₘᵢₙ. Diffracted component 260 represents the component of diffracted light 130 with the maximum replication distance γₘₐₓ in waveguide 105 with any of the non-uniform refractive index profiles 210a, 210b, and 210c or any non-uniform refractive index profile subject to the dispersion constraint V≥Vₘᵢₙ. Note that non-uniform refractive index profiles 210a, 210b, and 210c introduces a curvature into the propagation trajectory of the different components of diffracted light. It is evident from the right side of FIG. 6 that when waveguide 105 has a non-uniform refractive index profile, the difference between γₘₐₓ and γₘᵢₙ is small and the calculated ratio γₘₐₓ/γₘᵢₙ˜1.57.

In a further example, FIG. 7 is a plot of refractive index as a function of position in the thickness direction z of a waveguide having a thickness d=0.5 mm. FIG. 7 shows non-uniform refractive index profiles 310a, 310b, and 310c with a gradient at wavelengths of 440 nm, 532 nm, and 650 nm, respectively, and corresponding comparative uniform refractive index profiles 320a, 320b, and 320c at wavelengths of 440 nm, 532 nm, and 650 nm, respectively. Uniform refractive index profile 320c has an index of 2.00 throughout the thickness direction. Non-uniform refractive index profile 310c has a maximum value of about 1.98 at incident surface 102 (z=0 mm) and decreases monotonically in the thickness direction to a minimum value of about 1.38 at back surface 104 (z=0.5 mm). The variation in refractive index of non-uniform refractive index profile 310c can be expressed as

$${n}_{650} ( z ) = 1.3 + 0.7 * {( 1 + {e}^{11.4 * ( z - 0.326 )} )}^{- 1}$$

where n₆₅₀(z) represents refractive index as a function of z, the coordinate measuring position in the thickness direction, and z is expressed in units of mm. The average gradient of non-uniform refractive index profile 310c is about 1.20/mm. Uniform refractive index profile 320b was determined from uniform refractive index profile 320c and has a refractive index of 2.026. Uniform refractive index profile 320a was determined from uniform refractive index profile 220c and has a refractive index of 2.102. Non-uniform refractive index profiles 310a and 310b were determined from non-uniform refractive index profile 310c using the formulas above and Vₘᵢₙ.

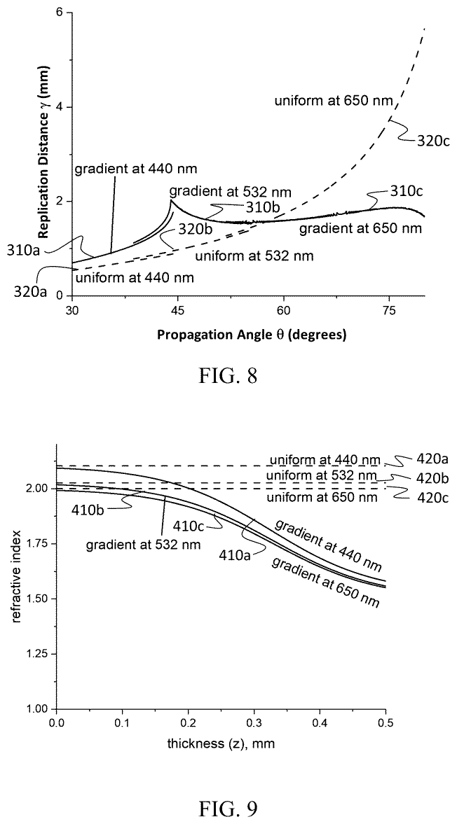

FIG. 8 shows the variation of replication distance γ with propagation angle θ for non-uniform refractive index profiles 310a, 310b, and 310c and for uniform refractive index profiles 320a, 320b, and 320c propagation angle θ. The range of propagation angle for each wavelength extends from θₘᵢₙ to θₘₐₓ, where θₘᵢₙ and θₘₐₓ are given in Table 1 above. The replication distance γ for uniform refractive index profiles 320a, 320b, and 320c show an appreciable increase as the propagation angle θ increases. The replication distance γ for non-uniform refractive index profiles 310a, 310b, and 310c, in contrast, are comparatively constant as the propagation angle θ increases. The calculated ratio γₘₐₓ/γₘᵢₙ≈2.91.

In still another example, FIG. 9 is a plot of refractive index as a function of position in the thickness direction z of a waveguide having a thickness d=0.5 mm. FIG. 9 shows non-uniform refractive index profiles 410a, 410b, and 410c with a gradient at wavelengths of 440 nm, 532 nm, and 650 nm, respectively, and corresponding comparative uniform refractive index profiles 420a, 420b, and 420c at wavelengths of 440 nm, 532 nm, and 650 nm, respectively. Uniform refractive index profile 420c has an index of 2.00 throughout the thickness direction. Non-uniform refractive index profile 410c has a maximum value of about 1.99 at incident surface 102 (z=0 mm) and decreases monotonically in the thickness direction to a minimum value of about 1.55 at back surface 104 (z=0.5 mm). The variation in refractive index of non-uniform refractive index profile 410c can be expressed as

$${n}_{650} ( z ) = 1.5 + 0.5 * {( 1 + {e}^{12.6 * ( z - 0.33 )} )}^{- 1}$$

where n₆₅₀(z) represents refractive index as a function of z, the coordinate measuring position in the thickness direction, and z is expressed in units of mm. The average gradient of non-uniform refractive index profile 410c is about 0.88/mm. Uniform refractive index profile 420b was determined from uniform refractive index profile 420c and has a refractive index of 2.026. Uniform refractive index profile 420a was determined from uniform refractive index profile 420c and has a refractive index of 2.102. Non-uniform refractive index profiles 410a and 410b were determined from non-uniform refractive index profile 410c using the formulas above and Vₘᵢₙ.

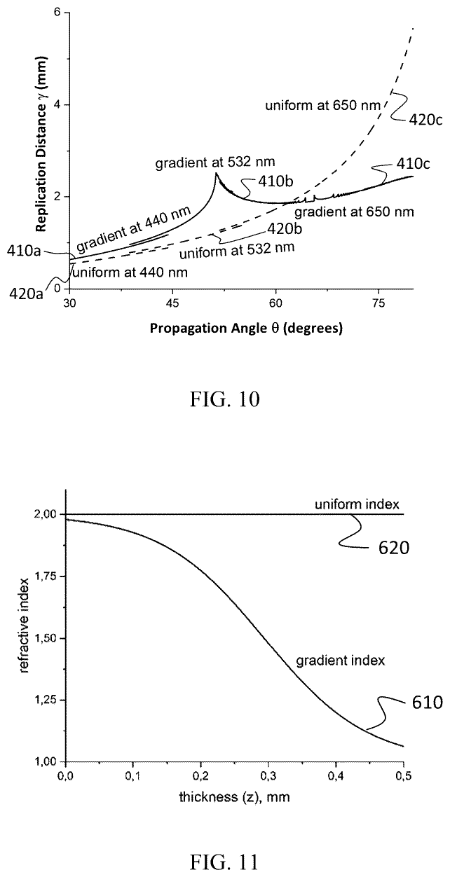

FIG. 10 shows the variation of replication distance γ with propagation angle θ for non-uniform refractive index profiles 410a, 410b, and 410c and for uniform refractive index profiles 420a, 420b, and 420c propagation angle θ. The range of propagation angle for each wavelength extends from θₘᵢₙ to θₘₐₓ, where θₘᵢₙ and θₘₐₓ are given in Table 1 above. The replication distance γ for uniform refractive index profiles 420a, 420b, and 420c show an appreciable increase as the propagation angle θ increases. The replication distance γ for non-uniform refractive index profiles 410a, 410b, and 410c, in contrast, are comparatively constant as the propagation angle θ increases. The calculated ratio γₘₐₓ/γₘᵢₙ≈3.96.

### EXAMPLES—INDEX GRADIENT—MONOCHROMATIC LIGHT

The following examples illustrate embodiments in which the incident light is monochromatic. The results presented are independent of the wavelength of the monochromatic light.

FIG. 11 is a plot of refractive index as a function of position in the thickness direction z of a waveguide having a thickness d=0.5 mm. FIG. 11 shows non-uniform refractive index profile 610 with a gradient and a comparative uniform refractive index profile 220. Uniform refractive index profile 620 has an index of 2.00 throughout the thickness direction. Non-uniform refractive index profile 610 has a maximum value of 1.98 at incident surface 102 (z=0 mm) and decreases monotonically in the thickness direction to a minimum value of 1.06 at back surface 104 (z=0.5 mm). The variation in refractive index of non-uniform refractive index profile 610 can be expressed as

$$n ( z ) = 1 + {( 1 + {e}^{13.1 * ( z - 0.294 )} )}^{- 1}$$

where n(z) represents refractive index as a function of z, the coordinate measuring position in the thickness direction, and z is expressed in units of mm. The average gradient of non-uniform refractive index profile 610 is about 1.84/mm.

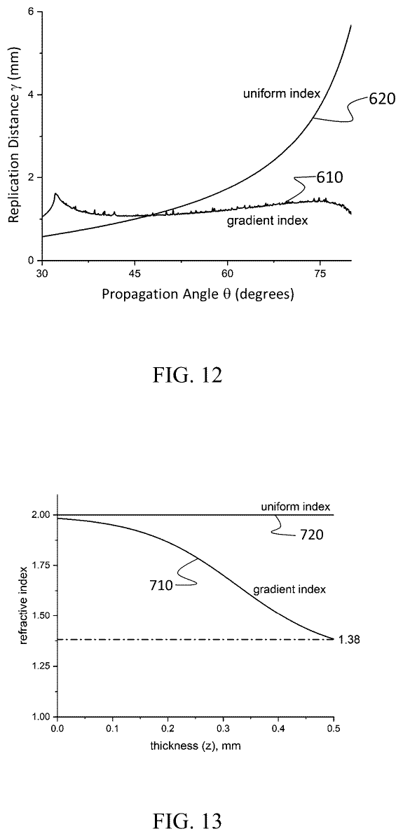

FIG. 12 shows the variation of replication distance γ with propagation angle θ for non-uniform refractive index profile 610 and uniform refractive index profile 620 over a range of propagation angles 30 extending from 30° to 80°. The replication distance γ for uniform refractive index profile 620 shows a significant increase as the propagation angle θ increases. The replication distance γ for non-uniform refractive index profile 610, in contrast, is comparatively constant as the propagation angle θ increases. Calculations indicate that the ratio γₘₐₓ/γₘᵢₙ=9.82 for a waveguide 105 with thickness 0.5 mm and constant refractive index of 2.0. Similar calculations indicate that when waveguide 105 with thickness 0.5 mm has a constant refractive index of 1.5, the ratio γₘₐₓ/γₘᵢₙ=6.34. When waveguide 105 has a non-uniform refractive index profile, the difference between γₘₐₓ and γₘᵢₙ is small and the calculated ratio γₘₐₓ/γₘᵢₙ≈1.54.

In a further example, FIG. 13 is a plot of refractive index as a function of position in the thickness direction z of a waveguide having a thickness d=0.5 mm. FIG. 13 shows non-uniform refractive index profile 710 with a gradient and a comparative uniform refractive index profile 720. Uniform refractive index profile 720 has an index of 2.00 throughout the thickness direction. Non-uniform refractive index profile 710 has a maximum value of 1.98 at incident surface 102 (z=0 mm) and decreases monotonically in the thickness direction to a minimum value of 1.38 at back surface 104 (z=0.5 mm). The variation in refractive index of non-uniform refractive index profile 710 can be expressed as

$$n ( z ) = 1.3 + 0.7 {( 1 + {e}^{11.4 * ( z - 0.326 )} )}^{- 1}$$

where n(z) represents refractive index as a function of z, the coordinate measuring position in the thickness direction, and z is expressed in units of mm. The average gradient of non-uniform refractive index profile 310 is about 1.20/mm.

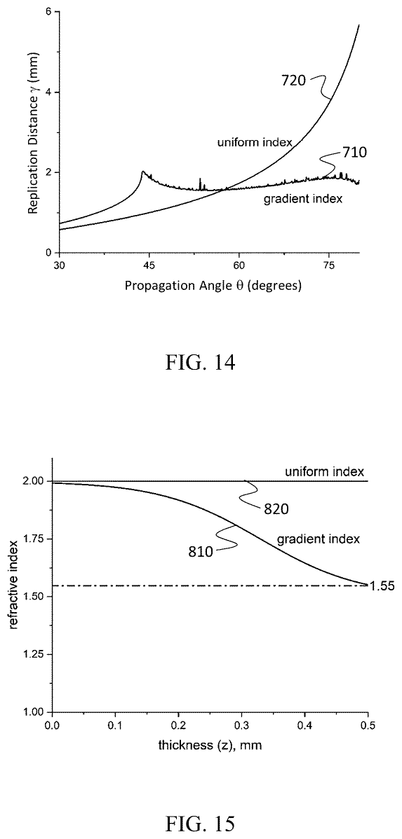

FIG. 14 shows the variation of replication distance γ with propagation angle θ for non-uniform refractive index profile 710 and uniform refractive index profile 720 over a range of propagation angles 30 extending from 30° to 80°. The replication distance γ for uniform refractive index profile 720 shows a significant increase as the propagation angle θ increases. The replication distance γ for non-uniform refractive index profile 710, in contrast, is comparatively constant as the propagation angle θ increases and the calculated ratio γₘₐₓ/γₘᵢₙ≈2.79.

In still another example, FIG. 15 is a plot of refractive index as a function of position in the thickness direction z of a waveguide having a thickness d=0.5 mm. FIG. 15 shows non-uniform refractive index profile 810 with a gradient and a comparative uniform refractive index profile 820. Uniform refractive index profile 820 has an index of 2.00 throughout the thickness direction. Non-uniform refractive index profile 810 has a maximum value of 1.99 at incident surface 102 (z=0 mm) and decreases monotonically in the thickness direction to a minimum value of 1.55 at back surface 104 (z=0.5 mm). The variation in refractive index of non-uniform refractive index profile 810 can be expressed as

$$n ( z ) = 1.5 + 0.5 {( 1 + {e}^{12.6 * ( z - 0.33 )} )}^{- 1}$$

where n(z) represents refractive index as a function of z, the coordinate measuring position in the thickness direction, and z is expressed in units of mm. The average gradient of non-uniform refractive index profile 810 is about 0.88/mm.

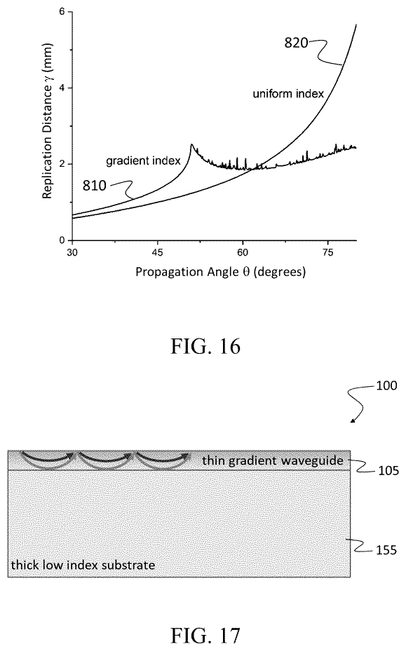

FIG. 16 shows the variation of replication distance γ with propagation angle θ for non-uniform refractive index profile 810 and uniform refractive index profile 820 over a range of propagation angles 30 extending from 30° to 80°. The replication distance γ for uniform refractive index profile 820 shows a significant increase as the propagation angle θ increases. The replication distance γ for non-uniform refractive index profile 810, in contrast, is comparatively constant as the propagation angle θ increases and the calculated ratio γₘₐₓ/γₘᵢₙ≈3.78.

The examples above for polychromatic and monochromatic light illustrate that the difference between γₘₐₓ and γₘᵢₙ and the ratio γₘₐₓ/γₘᵢₙ are reduced when waveguide 105 is designed to include a non-uniform refractive index profile instead of a uniform refractive index profile. Reductions in the difference between γₘₐₓ and γₘᵢₙ and the ratio γₘₐₓ/γₘᵢₙ improve brightness uniformity at outcoupling gratings 115. The ratio γₘₐₓ/γₘᵢₙ can be adjusted by varying the nature of the non-uniform refractive index profile to accommodate convenience and practical considerations in preparing waveguides with a gradient or other non-uniformity in refractive index for any wavelength, combination of wavelengths, or wavelength range.

In various embodiments, waveguide 105 has a non-uniform refractive index profile that provides a ratio γₘₐₓ/γₘᵢₙ less than or equal to 6.0, or less than or equal to 5.0, or less than or equal to 4.0, or less than or equal to 3.0, or less than or equal to 2.0, or less than or equal to 1.5, or in the range from 1.0 to 6.0, or in the range from 1.5 to 5.5, or in the range from 2.0 to 5.0, or in the range from 2.5 to 4.5 for incident light including one or more, or two or more, or three or more, or four or more or five or more, or six or more or ten or more, or twenty or more wavelengths of light between 440 nm and 650 nm.

### EXAMPLES—LAMINATES & STACKS

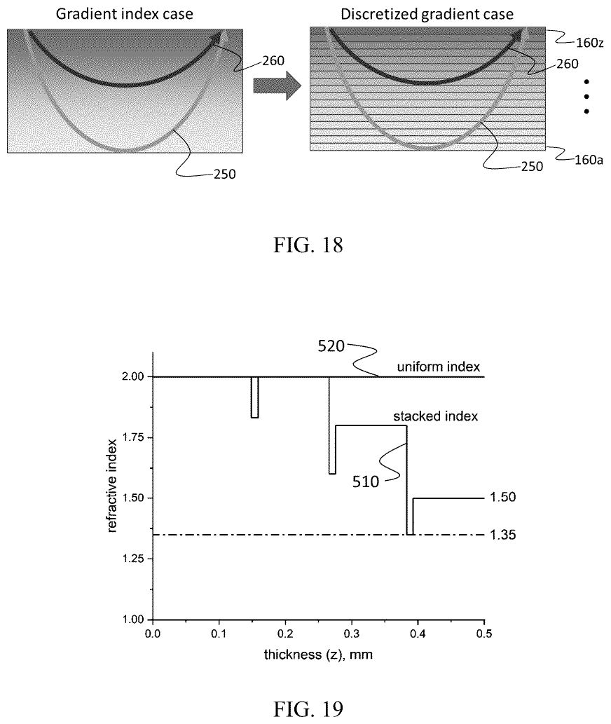

Further embodiments of optical elements and waveguides are illustrated in FIGS. 17 and 18. FIG. 17 shows an embodiment of a waveguide 105 on a substrate 155. Substrate 155 provides mechanical support to waveguide 105 and can be formed from an ordinary material (e.g., glass, ceramic, crystal). Light transmission is limited to waveguide 105 and no particular requirements for the refractive index of substrate 155 need to be met. Substrate 155, for example, can have a low refractive index and in particular, a refractive index less than the refractive index of waveguide 105. The compositions needed to realize the refractive index of waveguide 105 are typically expensive, so it is advantageous to reduce the thickness of waveguide 105. As the thickness of waveguide 105 decreases, however, waveguide 105 becomes fragile and difficult to handle. Substrate 155 can be a low-cost material that maintains mechanical integrity of waveguide 105 to facilitate cost reduction of optical element 100.

FIG. 18 shows a variation of the embodiment depicted on the right side of FIG. 6. In FIG. 18, the non-uniform refractive index profile is formed as a series of discrete-index regions that vary in a stepwise fashion in the thickness direction of the waveguide. In an embodiment, the discrete-index regions are layers where each layer differs in refractive index. Each of the discrete-index regions 160a, . . . , 160z are regions of uniform of refractive index where the refractive index in adjacent ones of the discrete-index regions 160a . . . 160z differ. The change in refractive index from one discrete-index region to the next discrete-index region is a step change. In the embodiment shown in FIG. 18, Discrete-index region 160z has the highest refractive index and the refractive index steps down in the thickness direction at the transition between each discrete-index region to reach a minimum refractive index in discrete-index region 160a.

The refractive index of each of the discrete-index regions is within the ranges described hereinabove and the average step change in index between adjacent ones of the discrete-index regions is greater than or equal to 0.001, or greater than or equal to 0.005, or, greater than or equal to 0.010, or greater than or equal to 0.020, or greater than or equal to 0.050, or greater than or equal to 0.070, or greater than or equal to 0.100, or less than or equal to 0.300, or less than or equal to 0.200, or less than or equal to 0.100, or less than or equal to 0.050, or in the range from 0.001 to 0.300, or in the range from 0.001 to 0.200, or in the range from 0.001 to 0.100, or in the range from 0.001 to 0.050, in the range from 0.005 to 0.300, or in the range from 0.005 to 0.200, or in the range from 0.005 to 0.100, or in the range from 0.005 to 0.050, or in the range from 0.010 to 0.300, or in the range from 0.010 to 0.200, or in the range from 0.010 to 0.100, or in the range from 0.010 to 0.050.

The average number of discrete-index regions per mm of distance in the thickness direction is greater than or equal to 2, or greater than or equal to 6, or greater than or equal to 10, or greater than or equal to 15, or greater than or equal to 20, or greater than or equal to 30, or greater than or equal to 40, or greater than or equal to 50, or less than or equal to 100, or less than or equal to 90, or less than or equal to 80, or less than or equal to 70, or less than or equal to 60, or less than or equal to 50, or in a range from 2 to 100, or in a range from 6 to 90, or in a range from 10 to 80, or in a range from 20 to 70, or in a range from 30 to 60. or in a range from 2 to 30, or in a range from 3 to 20, or in a range from 4 to 15, or in a range from 5 to 10.

The embodiment depicted in FIG. 18 may be constructed as a laminate structure of the individual discrete-index regions (e.g., by stacking and fusing) or by controlling the composition to vary the refractive index in the thickness direction as the waveguide is fabricated. For example, discrete-index region 160a may be formed from a glass with a low concentration of high-index modifiers to a finite thickness. A second discrete-index region 160b formed from a glass with a slightly higher concentration of high-index modifiers may be formed on discrete-index region 160a to a finite thickness etc. to build up the waveguide depicted in FIG. 18.

FIG. 19 is a plot of refractive index as a function of position in the thickness direction z of a waveguide having a thickness d=0.5 mm. FIG. 19 shows non-uniform refractive index profile 510 with a series of discrete-index regions and a comparative uniform refractive index profile 520. Uniform refractive index profile 520 has an index of 2.00 throughout the thickness direction. Non-uniform refractive index profile 510 consists of a series of seven discrete-index regions with the refractive indices and thicknesses, listed in order of depth in the z-direction, shown in Table 1. Non-uniform refractive index profile 510 includes a series of step changes in index. The step changes are discontinuities in refractive index. Step increases and step decreases in refractive index are included in the arrangement of layers of non-uniform refractive index profile 510.

TABLE 1

| Layer # | 1 | 2 | 3 | 4 | 5 | 6 | 7 |
|---|---|---|---|---|---|---|---|
| Thickness (mm) | 0.149 | 0.010 | 0.107 | 0.010 | 0.107 | 0.010 | 0.107 |
| Index | 2.00 | 1.83 | 2.00 | 1.60 | 1.80 | 1.35 | 1.50 |

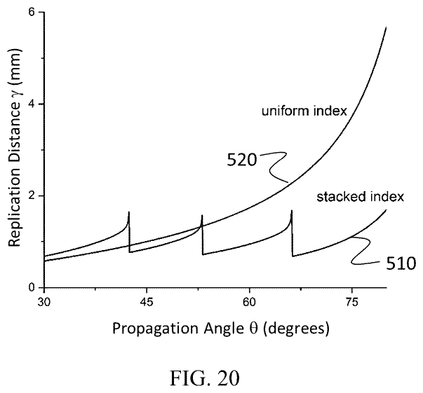

FIG. 20 shows the variation of replication distance γ with propagation angle θ for non-uniform refractive index profile 510 and uniform refractive index profile 520 over a range of propagation angles 30 extending from 30° to 80°. The replication distance γ for uniform refractive index profile 520 shows a significant increase as the propagation angle θ increases. The replication distance γ for non-uniform refractive index profile 510, in contrast, shows a much lower overall variation in replication distance γ as the propagation angle θ increases. replication distance γ increases with propagation angle θ in each of the thicker layers (#1, #3, #5, #7) is reduced by the thin transition layers (#2, #4, #6) and reset to a lower value. Each of the thicker layers is designed to maintain a small range of replication distance γ over a particular range of propagation angle θ. In this way, the perpetual increase in replication distance γ with propagation angle θ observed for uniform refractive index profile 520 is arrested and a more uniform replication distance γ is achieved. The calculated ratio γₘₐₓ/γₘᵢₙ≈2.49 for non-uniform refractive index profile 510.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations, and variations of the disclosed embodiments that incorporate the spirit and substance of the illustrated embodiments may occur to persons skilled in the art, the description should be construed to include everything within the scope of the appended claims and their equivalents.

What is claimed is:

1. An optical element comprising:
an entrance light-coupling element, the entrance light-coupling element configured to diffract light received over a field of view defined by a first angular range, the light comprising a wavelength in the range from 440 nm to 650 nm, the first angular range comprising a plurality of incidence angles a extending from a minimum incidence angle αₘᵢₙ to a maximum incidence angle αₘₐₓ;
a waveguide, the waveguide configured to receive the light diffracted by the entrance light-coupling element and to transmit the diffracted light internally over a second angular range to a first exit light-coupling element, the second angular range comprising a plurality of propagation angles θ extending from a minimum propagation angle θₘᵢₙ to a maximum propagation angle θₘₐₓ, the light transmitted at each of the propagation angles θ having a replication distance γ, the light transmitted over the second angular range including a maximum replication distance γₘₐₓ at the maximum propagation angle and a minimum replication distance γₘᵢₙ the minimum propagation angle, the ratio
$$\frac{{γ}_{max}}{{γ}_{min}}$$
less than or equal to 6.0, the first exit light-coupling element diffracting the transmitted light out of the waveguide.

2. The optical element of claim 1, wherein the light diffracted by the entrance light-coupling element is polychromatic.

3. The optical element of claim 1, wherein the light diffracted by the entrance light-coupling element comprises three or more wavelengths in the range from 440 nm to 650 nm.

4. The optical element of claim 1, wherein the waveguide is curved.

5. The optical element of claim 1, wherein the waveguide has a thickness d less than 2.0 mm.

6. The optical element of claim 1, wherein the absolute value of the minimum incidence angle αₘᵢₙ is greater than or equal to 0° and the absolute value of the maximum incidence angle αₘₐₓ is less than or equal to 30°.

7. The optical element of claim 1, wherein the waveguide transmits the light diffracted by the entrance light-coupling element internally by total internal reflectance.

8. The optical element of claim 7, wherein the second angular range includes greater than or equal to 60% of the range of angles capable of being transmitted internally by total internal reflection within the waveguide.

9. The optical element of claim 1, wherein the minimum propagation angle θₘᵢₙ is greater than or equal to 15° and the maximum propagation angle θₘₐₓ is less than or equal to 80°.

10. The optical element of claim 1, wherein the ratio
$$\frac{{γ}_{max}}{{γ}_{min}}$$
is less than or equal to 4.0.

11. The optical element of claim 1, wherein the ratio
$$\frac{{γ}_{max}}{{γ}_{min}}$$
is less than or equal to 2.0.

12. The optical element of claim 1, wherein the waveguide comprises a non-uniform refractive index.

13. The optical element of claim 12, wherein the non-uniform refractive index comprises a non-uniform refractive index profile that varies in a thickness direction extending from an incidence surface of the waveguide to a back surface of the waveguide, the waveguide receiving the light diffracted by the entrance light-coupling element at the incidence surface, the back surface spaced apart from the incidence surface by a thickness of the waveguide.

14. The optical element of claim 13, wherein the non-uniform refractive index profile comprises a refractive index at the incidence surface greater than the refractive index at the back surface.

15. The optical element of claim 13, wherein the non-uniform refractive index profile varies continuously between the incidence surface and the back surface.

16. The optical element of claim 13, wherein the non-uniform refractive index profile comprises a refractive index that decreases monotonically between the incidence surface and the back surface.

17. The optical element of claim 13, wherein the non-uniform refractive index profile comprises a refractive index with an average gradient in the thickness direction, the average gradient greater than or equal to 0.50/mm.

18. The optical element of claim 13, wherein the non-uniform refractive index profile includes a minimum refractive index and a maximum refractive index, the minimum refractive index less than or equal to 1.6 and the maximum refractive index greater than or equal to 1.8.

19. The optical element of claim 18, wherein the difference between the maximum refractive index and the minimum refractive index is greater than or equal to 0.4.

20. The optical element of claim 13, wherein the non-uniform refractive index profile varies discretely between the incidence surface and the back surface.
